(19) United States
(12) Patent Application Publication
(10) Pub. No.: US 2025/0231445 A1
(43) Pub. Date: Jul. 17, 2025

(54) LIQUID CRYSTAL ELEMENT

(71) Applicant: Japan Display Inc., Tokyo (JP)

(72) Inventors: Toshiharu MATSUSHIMA, Tokyo (JP); Shunichi KIMURA, Tokyo (JP)

(21) Appl. No.: 19/023,967

(22) Filed: Jan. 16, 2025

(30) Foreign Application Priority Data
Jan. 17, 2024 (JP) 2024-005130

(51) Int. Cl. G02F 1/1343; G02F 1/1335

(52) U.S. Cl. CPC G02F 1/134309; G02F 1/133512

(57) ABSTRACT

According to an aspect, a liquid crystal element includes: a first substrate on which element sets are disposed, each element set including an electric resistance film, a first electrode, and a second electrode, the first and second electrodes being electrically coupled to the electric resistance film; a second substrate on which a third electrode is disposed; and a liquid crystal layer between the first and second substrates. Each electric resistance film has a strip shape extending in a first direction in a plan view. In a plan view, the first and second electrodes extend in the first direction and overlap the electric resistance film in a state where the first and second electrodes face each other in a second direction orthogonal to the first direction. The element sets are arranged in the second direction in a plan view. The third electrode overlaps the electric resistance films in a plan view.

### CROSS-REFERENCE TO RELATED APPLICATION

This application claims the benefit of priority from Japanese Patent Application No. 2024-005130 filed on Jan. 17, 2024, the entire contents of which are incorporated herein by reference.

### BACKGROUND

### 1. Technical Field

What is disclosed herein relates to a liquid crystal element.

### 2. Description of the Related Art

Japanese Patent Application Laid-open Publication No. 2014-52584 (JP-A-2014-52584) discloses a headlight capable of controlling light distribution. The headlight of JP-A-2014-52584 reflects light from a light source by using a mirror, converges the reflected light with a lens, and projects light toward the front side of the vehicle. The direction of light projection is adjusted by adjusting the angle of the mirror.

Japanese Patent Application Laid-open Publication No. 2023-63255 (JP-A-2023-63255) discloses an illumination device including a lamp unit including a light source, and an arm coupled to the lamp unit. The arm includes a first arm and a second arm coupled to each other in a relatively rotatable manner. The lamp unit and the second arm are coupled to each other in a relatively rotatable manner. The emission direction of light from the light source is adjusted by adjusting the angle between the first and second arms and the angle between the lamp unit and the second arm.

In a device capable of adjusting the emission direction of light as in JP-A-2014-52584 or JP-A-2023-63255, the emission direction of light is adjusted through operation of a movable part in a mechanism including a plurality of mechanical components. The configuration of such a device is desired to be simplified.

For the foregoing reasons, there is a need for a liquid crystal element capable of easily adjusting the emission direction of light.

### SUMMARY

According to an aspect, a liquid crystal element includes: a first substrate on which a plurality of element sets are disposed, each element set including an electric resistance film, a first electrode, and a second electrode, the first electrode and the second electrode being electrically coupled to the electric resistance film; a second substrate on which a third electrode is disposed; and a liquid crystal layer positioned between the first and second substrates. Each of the electric resistance films has a strip shape extending in a first direction in a plan view. In a plan view, the first electrode and the second electrode extend in the first direction and overlap the electric resistance film in a state in which the first electrode and the second electrode face each other in a second direction orthogonal to the first direction. The element sets are arranged in the second direction in a plan view. The third electrode overlaps the electric resistance films in a plan view.

According to an aspect, a liquid crystal element includes: a first substrate on which an electric resistance film, a plurality of first electrodes, and a plurality of second electrodes are disposed, the first and second electrodes being electrically coupled to the electric resistance film; a second substrate on which a third electrode is disposed; and a liquid crystal layer positioned between the first and second substrates. In a plan view, the first and second electrodes extend in a first direction and overlap the electric resistance film in a state in which the first electrode and the second electrode are alternately arranged in a second direction orthogonal to the first direction. The third electrode overlaps the electric resistance film in a plan view.

According to an aspect, a liquid crystal element includes: a first substrate on which a plurality of element sets and a plurality of light-shielding layers are disposed, each element set including an electric resistance film, a first electrode, and a second electrode, the first electrode and the second electrode being electrically coupled to the electric resistance film; a second substrate on which a third electrode is disposed; and a liquid crystal layer positioned between the first and second substrates. The electric resistance films each have a strip shape extending in a first direction in a plan view. In a plan view, the first electrode and the second electrode extend in the first direction and overlap the electric resistance film in a state in which the first electrode and the second electrode face each other in a second direction orthogonal to the first direction. The element sets are arranged in the second direction in a plan view. In a plan view, each of the light-shielding layers has a strip shape extending in the first direction and overlaps a gap between two of the element sets adjacent to each other in the second direction. The third electrode overlaps the electric resistance films in a plan view.

### BRIEF DESCRIPTION OF THE DRAWINGS

FIG. 1 is a conceptual diagram of a liquid crystal element according to a first embodiment of the present disclosure;

FIG. 2 is a plan view of the liquid crystal element according to the first embodiment of the present disclosure;

FIG. 3 is a sectional view of the liquid crystal element along line III-III illustrated in FIG. 2;

FIG. 4 is a diagram illustrating the potential of an electric resistance film and the phase difference of emission light passing through a liquid crystal layer when the liquid crystal element refracts emission light L in a fourth direction;

FIG. 5 is a diagram illustrating the potential of an electric resistance film and the phase difference of emission light passing through the liquid crystal layer when the liquid crystal element refracts emission light in a fifth direction;

FIG. 6 is a sectional view of a liquid crystal element according to a modification of the first embodiment of the present disclosure;

FIG. 7 is a diagram illustrating the potential of an electric resistance film and the phase difference of emission light passing through the liquid crystal layer when the liquid crystal element according to the modification of the first embodiment refracts emission light in the fourth direction;

FIG. 8 is a sectional view of a liquid crystal element according to a second embodiment of the present disclosure;

FIG. 9 is a diagram illustrating the potential of an electric resistance film and the phase difference of emission light passing through the liquid crystal layer when the liquid crystal element according to the second embodiment refracts emission light;

FIG. 10 is a sectional view of a liquid crystal element according to a modification of a third embodiment of the present disclosure;

FIG. 11 is a diagram illustrating the potential of an electric resistance film and the phase difference of emission light passing through the liquid crystal layer when the liquid crystal element according to the third embodiment refracts emission light in the fourth direction;

FIG. 12 is a diagram illustrating the potential of the electric resistance film and the phase difference of emission light passing through the liquid crystal layer when a liquid crystal element according to a comparative example refracts emission light in the fourth direction; and

FIG. 13 is a graph illustrating an example of the relation between the refraction angle and the intensity of both emission light emitted from the liquid crystal element of the third embodiment and emission light emitted from the liquid crystal element of the comparative example.

### DETAILED DESCRIPTION

Embodiments of the present disclosure will be described below with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

A first direction D1 and a second direction D2 illustrated in the drawings correspond to directions parallel to the plate surfaces of substrates included in a liquid crystal element 1. A side to which an arrow points in each direction corresponds to its positive side, and the opposite side corresponds to its negative side. The positive and negative sides in the first direction D1 and the positive and negative sides in the second direction D2 correspond to sides of the liquid crystal element 1. A third direction D3 corresponds to the thickness direction of the liquid crystal element 1, the positive side in the third direction D3 corresponds to the front surface side of the liquid crystal element 1, and the negative side in the third direction D3 corresponds to the back surface side of the liquid crystal element 1. In the present specification, a “plan view” is a view of the liquid crystal element 1 in the third direction D3. The first direction D1, the second direction D2, and the third direction D3 are exemplary, and the present disclosure is not limited to these directions.

### First Embodiment

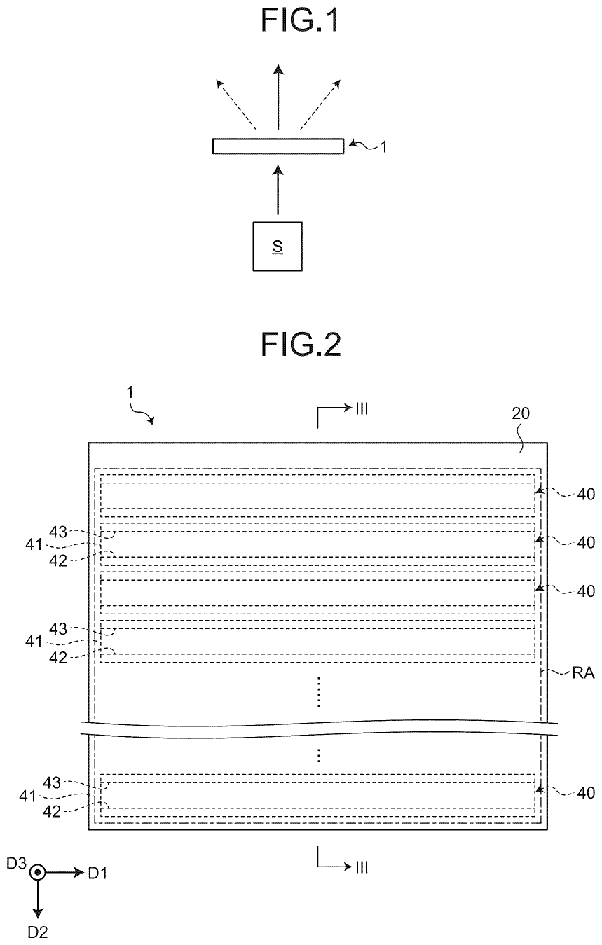

FIG. 1 is a conceptual diagram of the liquid crystal element 1 according to a first embodiment of the present disclosure. The liquid crystal element 1 is a refractive plate that refracts light. Emission light L emitted from a light source S is incident on the liquid crystal element 1. The light source S is, for example, an illumination device such as a vehicle headlight or a spotlight.

When no voltage is applied, the liquid crystal element 1 transmits the emission light L as illustrated with the solid arrow without changing the direction (emission direction) in which the emission light L travels. When voltage is applied, the liquid crystal element 1 refracts the emission light L in one of two directions illustrated with the dashed arrows in the first embodiment (to be described later in detail).

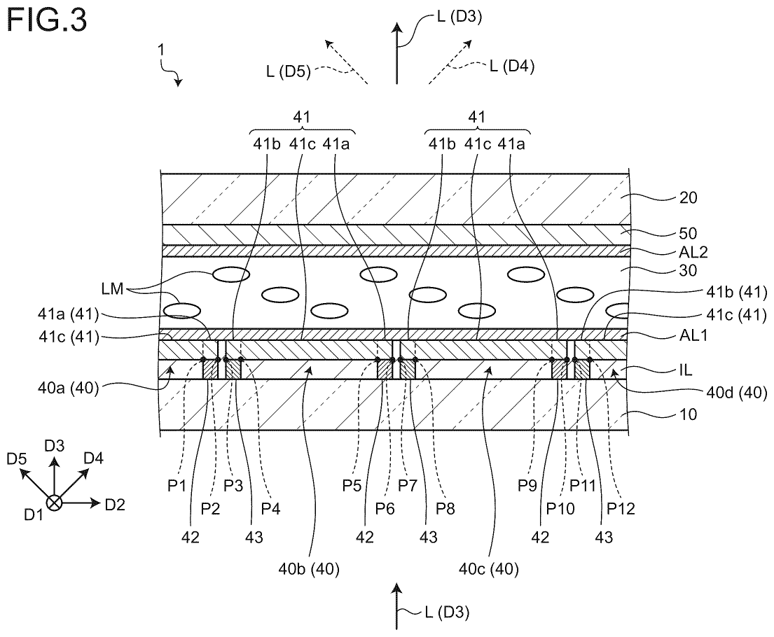

FIG. 2 is a plan view of the liquid crystal element 1 according to the first embodiment of the present disclosure. FIG. 3 is a sectional view of the liquid crystal element 1 along line III-III illustrated in FIG. 2. The sectional view of the liquid crystal element 1 illustrated in FIG. 3 illustrates a sectional shape of the liquid crystal element 1 along a plane orthogonal to the first direction D1.

The liquid crystal element 1 includes a first substrate 10, a second substrate 20, and a liquid crystal layer 30. The first substrate 10 and the second substrate 20 overlap each other in a plan view. The first substrate 10 and the second substrate 20 each have a light-transmitting property. The first substrate 10 and the second substrate 20 are, for example, glass substrates, resin substrates, or resin films.

A plurality of element sets 40, an insulating layer IL, and a first alignment film ALL are disposed on the first substrate 10. Each element set 40 includes an electric resistance film 41, a first electrode 42, and a second electrode 43.

The electric resistance film 41 has a strip shape extending in the first direction D1 in a plan view. The material of the electric resistance film 41 is a light-transmitting conductive material such as indium gallium zinc oxide (IGZO). The electric resistance value of the electric resistance film 41 is larger than the electric resistance values of the first and second electrodes 42 and 43.

The first and second electrodes 42 and 43 are electrically coupled to the electric resistance film 41. In a plan view, the first electrode 42 extends in the first direction D1 and overlaps the electric resistance film 41 on a first end side (positive side) of the electric resistance film 41 in the second direction D2. The first electrode 42 contacts the electric resistance film 41.

In a plan view, the second electrode 43 extends in the first direction D1 and overlaps the electric resistance film 41 on a second end side (negative side) of the electric resistance film 41 in the second direction D2. The second electrode 43 contacts the electric resistance film 41.

The first and second electrodes 42 and 43 overlap the electric resistance film 41 in a state in which the first and second electrodes 42 and 43 face each other in the second direction D2 in a plan view.

In the electric resistance film 41, a portion overlapping the first electrode 42 in a plan view is referred to as a first overlap portion 41a, a portion overlapping the second electrode 43 in a plan view is referred to as a second overlap portion 41b, and a portion between the first and second overlap portions 41a and 41b is referred to as a middle portion 41c. In the second direction D2, the length of the middle portion 41c is longer than the sum of the length of the first overlap portion 41a and the length of the second overlap portion 41b.

In the present embodiment, in the second direction D2, an end of the electric resistance film 41 on the positive side coincides with an end of the first electrode 42 on the positive side, and an end of the electric resistance film 41 on the negative side coincides with an end of the second electrode 43 on the negative side; but they do not necessarily need to coincide.

The element sets 40 are arranged in the second direction D2. As described above, the element sets 40 each include the strip-shaped electric resistance film 41 extending in the first direction D1. The electric resistance films 41 are arranged in the second direction D2 in a state in which two electric resistance films 41 adjacent to each other in the second direction D2 are separated from each other. In a plan view, the electric resistance films 41 overlap a refraction region RA that refracts the emission light L.

The element sets 40 are electrically insulated from each other by the insulating layer IL. Four element sets 40 are illustrated in FIG. 3. A first element set 40a, a second element set 40b, a third element set 40c, and a fourth element set 40d illustrated in FIG. 3 are arranged in the stated order from the negative side toward the positive side in the second direction D2.

The first alignment film AL1 is disposed on the positive side of the element sets 40 and the insulating layer IL in the third direction D3.

A third electrode 50 and a second alignment film AL2 are disposed on the second substrate 20.

The third electrode 50 overlaps the electric resistance films 41 in a plan view. The material of the first electrodes 42, the second electrodes 43, and the third electrode 50 is a light-transmitting conductive material such as indium tin oxide (ITO), indium zinc oxide (IZO), indium gallium oxide (IGO), or indium gallium zinc oxide (IGZO).

The second alignment film AL2 is disposed on the negative side of the third electrode 50 in the third direction D3.

The liquid crystal layer 30 is positioned between the first substrate 10 and the second substrate 20. The liquid crystal layer 30 is sandwiched between the first alignment film AL1 and the second alignment film AL2. The first alignment film AL1 and the second alignment film AL2 are to set the alignment (initial alignment) of liquid crystal molecules LM contained in the liquid crystal layer 30 when no voltage is applied to the liquid crystal element 1. The alignment direction of the first alignment film AL1 and the alignment direction of the second alignment film AL2 are orthogonal to each other in a plan view.

The liquid crystal element 1 is a twisted nematic (TN) liquid crystal element. However, the liquid crystal element 1 is not limited to a twisted nematic liquid crystal element.

The following describes operation when the liquid crystal element 1 refracts the emission light L from the light source S. The emission light L is incident on the liquid crystal element 1 in the third direction D3 from the back surface of the first substrate 10. A reference sign inside parentheses assigned to the emission light L indicates the direction in which the emission light L travels. In FIG. 3, the emission light L from the liquid crystal element 1 is illustrated on the positive side of the liquid crystal element 1 in the third direction D3.

When no potential is applied to the liquid crystal element 1, the emission light L from the liquid crystal element 1 travels in the third direction D3. When potential is applied to the liquid crystal element 1, the emission light L from the liquid crystal element 1 travels in a fourth direction D4 or a fifth direction D5 as described later. In other words, when potential is applied, the liquid crystal element 1 refracts the emission light L in the fourth direction D4 or the fifth direction D5.

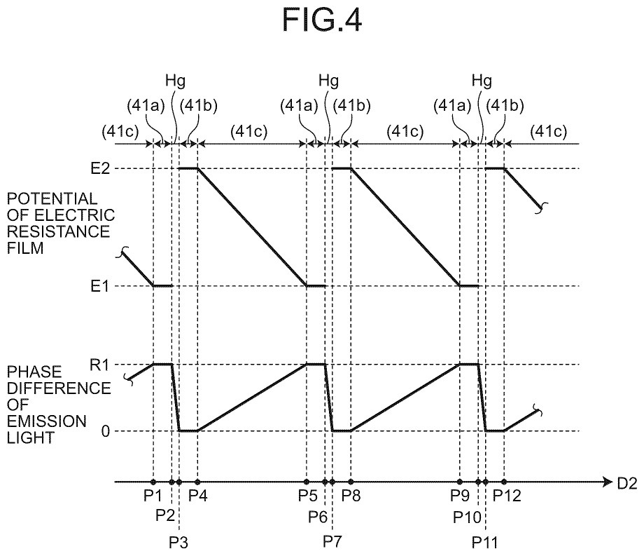

FIG. 4 is a diagram illustrating the potential of each electric resistance film 41 and the phase difference of the emission light L passing through the liquid crystal layer 30 when the liquid crystal element 1 refracts the emission light L in the fourth direction D4. The fourth direction D4 is a direction tilted on the positive side in the second direction D2 relative to the third direction D3 as illustrated in FIG. 3.

Points on the horizontal axis representing the second direction D2 illustrated in FIG. 4 indicate positions in the second direction D2. An arrow corresponding to a reference sign inside parentheses illustrated in FIG. 4 indicates the region of a portion of the electric resistance film 41. FIG. 3 also illustrates the points indicating the positions in the second direction D2.

A first point P1 and a second point P2 illustrated in FIGS. 3 and 4 correspond to the end of the first overlap portion 41a on the negative side in the second direction D2 and the end of the first overlap portion 41a on the positive side in the second direction D2, respectively, in the electric resistance film 41 of the first element set 40a illustrated in FIG. 3.

A third point P3, a fourth point P4, a fifth point P5, and a sixth point P6 illustrated in FIGS. 3 and 4 correspond to the end of the second overlap portion 41b on the negative side in the second direction D2, the end of the second overlap portion 41b on the positive side in the second direction D2, the end of the first overlap portion 41a on the negative side in the second direction D2, and the end of the first overlap portion 41a on the positive side in the second direction D2, respectively, in the electric resistance film 41 of the second element set 40b illustrated in FIG. 3.

A seventh point P7, an eighth point P8, a ninth point P9, and a tenth point P10 illustrated in FIGS. 3 and 4 correspond to the end of the second overlap portion 41b on the negative side in the second direction D2, the end of the second overlap portion 41b on the positive side in the second direction D2, the end of the first overlap portion 41a on the negative side in the second direction D2, and the end of the first overlap portion 41a on the positive side in the second direction D2, respectively, in the electric resistance film 41 of the third element set 40c illustrated in FIG. 3.

An eleventh point P11 and a twelfth point P12 illustrated in FIGS. 3 and 4 correspond to the end of the second overlap portion 41b on the negative side in the second direction D2 and the end of the second overlap portion 41b on the positive side in the second direction D2, respectively, in the electric resistance film 41 of the fourth element set 40d illustrated in FIG. 3.

When the liquid crystal element 1 refracts the emission light L in the fourth direction D4, a first potential E1 is applied to the first electrodes 42 and a second potential E2 higher than the first potential E1 is applied to the second electrodes 43 by a non-illustrated control circuit.

In this case, in one electric resistance film 41, the potential of the second overlap portion 41b (for example, portion between the third point P3 and the fourth point P4 in the second element set 40b) contacting the second electrode 43 is equal to the second potential E2. In one electric resistance film 41, the potential of the middle portion 41c (for example, portion between the fourth point P4 and the fifth point P5 in the second element set 40b) between the first electrode 42 and the second electrode 43 linearly changes from the second potential E2 to the first potential E1, from the negative side toward the positive side in the second direction D2. In one electric resistance film 41, the potential of the first overlap portion 41a (for example, portion between the fifth point P5 and the sixth point P6 in the second element set 40b) contacting the first electrode 42 is equal to the first potential E1.

The first potential E1 is applied to the third electrode 50 by the control circuit. The potential difference between the first potential E1 and the second potential E2 is determined based on the angle between the third direction D3 and the fourth direction D4. In other words, the degree of the tilt of the fourth direction D4 relative to the third direction D3 can be adjusted by the potential difference between the first potential E1 and the second potential E2.

An electric field generated by potential application to the first electrodes 42, the second electrodes 43, and the third electrode 50 acts on the liquid crystal layer 30 and tilts the liquid crystal molecules LM. Accordingly, the refractive index of the emission light L in the liquid crystal layer 30 changes in the second direction D2, and a phase difference occurs to the emission light L passing through the liquid crystal layer 30.

As for the phase of the emission light L passing through the liquid crystal layer 30 illustrated in FIG. 4, the phase at a position corresponding to the most negative end of one electric resistance film 41 in the second direction D2 (for example, the third point P3 in the second element set 40b) is taken as a reference (where the phase difference is 0 (zero)), and the maximum value of a phase difference caused by the potential of the electric resistance film 41 when potentials are applied to the first and second electrodes 42 and 43 is referred to as a first phase difference R1. A solid line representing the phase difference of the emission light L illustrated in FIG. 4 has a locus with the same phase as the reference phase.

The phase difference of the emission light L passing through the liquid crystal layer 30 changes in a zigzag pattern between 0 (zero) and the first phase difference R1 in the second direction D2. Specifically, the phase difference at portions of the liquid crystal layer 30 corresponding to the second overlap portions 41b is 0 (zero). The phase difference at portions of the liquid crystal layer 30 corresponding to the middle portions 41c linearly changes from 0 (zero) to the first phase difference R1, from the negative side toward the positive side in the second direction D2. The phase difference at portions of the liquid crystal layer 30 corresponding to the first overlap portions 41a is the first phase difference R1.

The phase difference between two electric resistance films 41 adjacent to each other in the second direction D2 (for example, between the second point P2 and the third point P3) linearly changes from the first phase difference R1 to 0 (zero), from the negative side toward the positive side in the second direction D2.

The degree of the gradient of the phase difference at portions of the liquid crystal layer 30 corresponding to the middle portions 41c corresponds to the angle between the third direction D3 and the fourth direction D4. In the second direction D2, the length of each portion of the liquid crystal layer 30 corresponding to a middle portion 41c is longer than the sum of the lengths of portions of the liquid crystal layer 30 corresponding to a first overlap portion 41a and a second overlap portion 41b. As the phase difference of the emission light L passing through the liquid crystal layer 30 changes as illustrated in FIG. 4, the emission light L is refracted in the liquid crystal layer 30 and exits in the fourth direction D4 from the liquid crystal element 1.

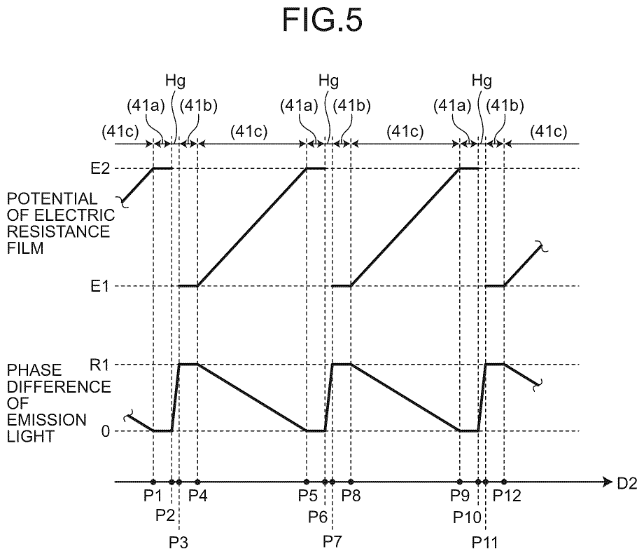

FIG. 5 is a diagram illustrating the potential of each electric resistance film 41 and the phase difference of the emission light L passing through the liquid crystal layer 30 when the liquid crystal element 1 refracts the emission light L in the fifth direction D5. The fifth direction D5 is a direction tilted on the negative side in the second direction D2 relative to the third direction D3 as illustrated in FIG. 3.

When the liquid crystal element 1 refracts the emission light L in the fifth direction D5, the second potential E2 is applied to the first electrodes 42 and the first potential E1 is applied to the second electrodes 43 by the control circuit.

In this case, as illustrated in FIG. 5, in one electric resistance film 41, the potential of the second overlap portion 41b (for example, portion between the third point P3 and the fourth point P4 in the second element set 40b) contacting the second electrode 43 is equal to the first potential E1. In one electric resistance film 41, the potential of the middle portion 41c (for example, portion between the fourth point P4 and the fifth point P5 in the second element set 40b) linearly changes from the first potential E1 to the second potential E2, from the negative side toward the positive side in the second direction D2. In one electric resistance film 41, the potential of the first overlap portion 41a (refer to FIG. 3; for example, portion between the fifth point P5 and the sixth point P6 in the second element set 40b) contacting the first electrode 42 is equal to the second potential E2.

The first potential E1 is applied to the third electrode 50 by the control circuit. The potential difference between the first potential E1 and the second potential E2 is determined based on the angle between the third direction D3 and the fifth direction D5. Thus, the degree of the tilt of the fifth direction D5 relative to the third direction D3 can be adjusted by the potential difference between the first potential E1 and the second potential E2.

Through potential application to the first electrodes 42, the second electrodes 43, and the third electrode 50, the refractive index of the emission light L in the liquid crystal layer 30 changes in the second direction D2, and a phase difference occurs to the emission light L passing through the liquid crystal layer 30.

As for the phase of the emission light L passing through the liquid crystal layer 30 illustrated in FIG. 5, the phase at a position corresponding to the most positive end of one electric resistance film 41 in the second direction D2 (for example, the sixth point P6 in the second element set 40b) is taken as a reference (where the phase difference is 0 (zero)), and the maximum value of a phase difference caused by potentials applied to the first and second electrodes 42 and 43 is referred to as the first phase difference R1.

The phase difference of the emission light L passing through the liquid crystal layer 30 changes in a zigzag pattern between 0 (zero) and the first phase difference R1 in the second direction D2. Specifically, the phase difference at portions of the liquid crystal layer 30 corresponding to the second overlap portions 41b is the first phase difference R1. The phase difference at portions of the liquid crystal layer 30 corresponding to the middle portions 41c linearly changes from the first phase difference R1 to 0 (zero), from the negative side toward the positive side in the second direction D2. The phase difference at portions of the liquid crystal layer 30 corresponding to the first overlap portions 41a is 0 (zero).

The phase difference between two electric resistance films 41 adjacent to each other in the second direction D2 linearly changes from 0 (zero) to the first phase difference R1, from the negative side toward the positive side in the second direction D2.

The degree of the gradient of the phase difference at portions of the liquid crystal layer 30 corresponding to the middle portions 41c corresponds to the angle between the third direction D3 and the fifth direction D5.

As the phase difference of the emission light L passing through the liquid crystal layer 30 changes as illustrated in FIG. 5, the emission light L is refracted in the liquid crystal layer 30 and exits in the fifth direction D5 from the liquid crystal element 1.

In this manner, the liquid crystal element 1 can refract the emission light L with a simple configuration. Moreover, the angle between the fourth direction D4 and the third direction D3 and the angle between the fifth direction D5 and the third direction D3 can be adjusted by potentials applied to the first and second electrodes 42 and 43. Thus, the liquid crystal element 1 can easily adjust the emission direction of light.

### Modification of First Embodiment

The following describes a liquid crystal element 1a according to a modification of the first embodiment with focus on difference from the liquid crystal element 1 of the above-described first embodiment.

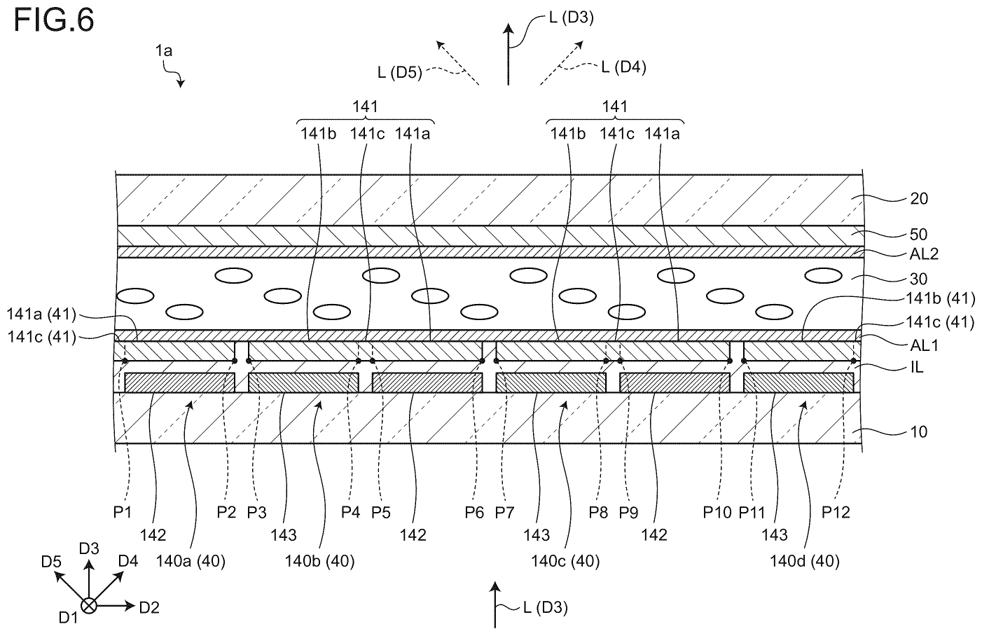

FIG. 6 is a sectional view of the liquid crystal element 1a according to the modification of the first embodiment of the present disclosure. In an element set 140 of the present modification, a first electrode 142 and a second electrode 143 are separated from an electric resistance film 141.

In the present modification, the lengths of the first electrode 142 and the second electrode 143 in the second direction D2 are longer than in the above-described first embodiment. In the present modification, in the element set 140, the position of the end of the second overlap portion 41b on the positive side in the second direction D2 and the position of the end of the first overlap portion 41a on the negative side in the second direction D2 are different from those in the above-described first embodiment in the second direction D2.

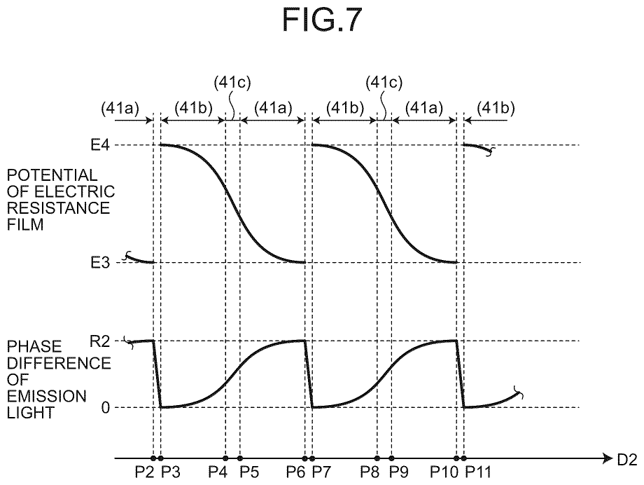

FIG. 7 is a diagram illustrating the potential of the electric resistance film 141 and the phase difference of the emission light L passing through the liquid crystal layer 30 when the liquid crystal element 1a according to the modification of the first embodiment refracts the emission light L in the fourth direction D4.

When the liquid crystal element 1a refracts the emission light L in the fourth direction D4, the first potential E1 is applied to the first electrode 142 and the second potential E2 is applied to the second electrode 143 by the control circuit.

Accordingly, as illustrated in FIG. 7, in one electric resistance film 141, the potential between the negative end and the positive end in the second direction D2 (for example, between the third point P3 and the sixth point P6 in the second element set 40b) changes in a curved line from a fourth potential E4 to a third potential E3 lower than the fourth potential E4. In the present modification, the curved line is an S-shaped line.

In the present modification, since the first electrode 142 and the second electrode 143 are separated from the electric resistance film 141, the third potential E3 is lower than the first potential E1 applied to the first electrode 142, and the fourth potential E4 is lower than the second potential E2 applied to the second electrode 143. The third potential E3, the fourth potential E4, and the curved line are determined by, for example, the distance from the first electrode 142 and the second electrode 143 to the electric resistance film 141 in the third direction D3 and the electric resistance value of the electric resistance film 141.

As for the phase of the emission light L passing through the liquid crystal layer 30 illustrated in FIG. 7, the phase at a position corresponding to the most negative end of one electric resistance film 141 in the second direction D2 (for example, the third point P3 in the second element set 40b) is taken as a reference (where the phase difference is 0 (zero)), and the maximum value of a phase difference caused by the potential of the electric resistance film 141 when potentials are applied to the first electrode 142 and the second electrode 143 is referred to as a second phase difference R2.

The phase difference of the emission light L passing through the liquid crystal layer 30 changes in a zigzag pattern between 0 (zero) and the second phase difference R2 in the second direction D2. Specifically, at a portion of the liquid crystal layer 30 corresponding to one electric resistance film 141, the phase difference between the negative end and the positive end in the second direction D2 (for example, between the third point P3 and the sixth point P6 in the second element set 40bs) changes in a curved line from 0 (zero) to the second phase difference R2, from the negative side toward the positive side in the second direction D2. In the present modification, the curved line is an S-shaped line.

As the phase difference of the emission light L passing through the liquid crystal layer 30 changes as illustrated in FIG. 7, the emission light L is refracted in the liquid crystal layer 30 and emitted in the fourth direction D4 from the liquid crystal element 1a. When the liquid crystal element 1a refracts the emission light L in the fifth direction D5, the second potential E2 is applied to the first electrode 142 and the first potential E1 is applied to the second electrode 143 by the control circuit.

### Second Embodiment

The following describes a liquid crystal element 1b according to a second embodiment with focus on difference from the liquid crystal element 1 of the above-described first embodiment.

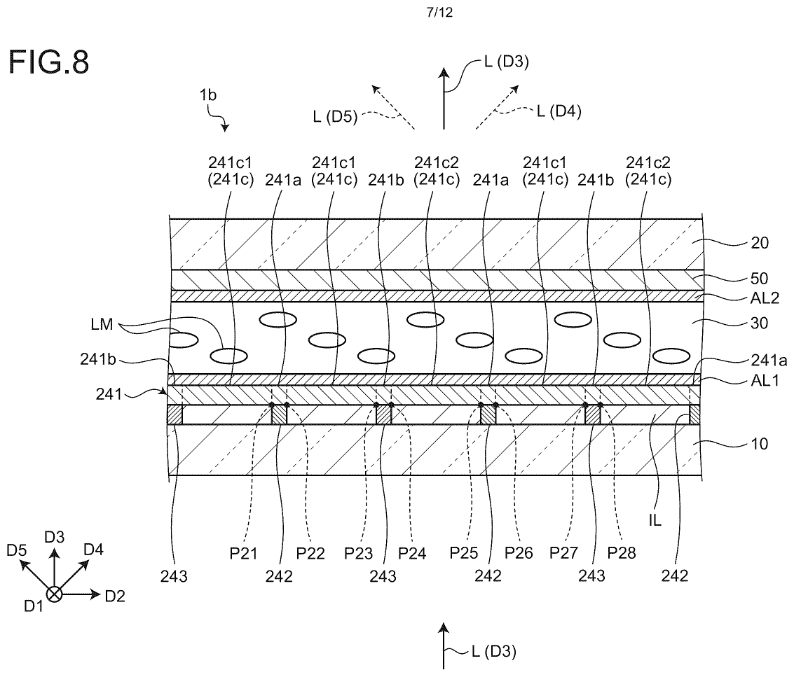

FIG. 8 is a sectional view of the liquid crystal element 1b according to the second embodiment of the present disclosure. The liquid crystal element 1b of the second embodiment includes one electric resistance film 241, a plurality of first electrodes 242, and a plurality of second electrodes 243 in place of the element sets 40 included in the liquid crystal element 1 of the above-described first embodiment.

The size of the electric resistance film 241 of the second embodiment in a plan view is different from that of the electric resistance film 41 of the above-described first embodiment. The number of electric resistance films 241 included in the liquid crystal element 1b is one. The electric resistance film 241 overlaps the refraction region RA in a plan view.

In a plan view, the first electrodes 242 and the second electrodes 243 extend in the first direction D1 and overlap the electric resistance film 241 in a state of being alternately arranged in the second direction D2.

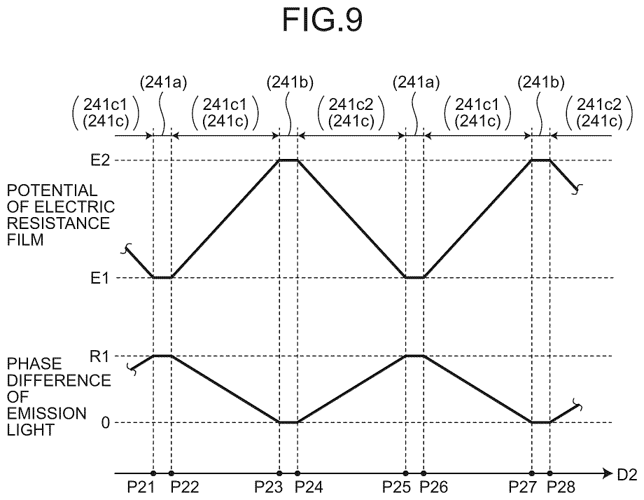

FIG. 9 is a diagram illustrating the potential of the electric resistance film 241 and the phase difference of the emission light L passing through the liquid crystal layer 30 when the liquid crystal element 1b according to the second embodiment refracts the emission light L. The liquid crystal element 1b of the second embodiment refracts the emission light L simultaneously in both the fourth direction D4 and the fifth direction D5.

A twenty-first point P21, a twenty-second point P22, a twenty-third point P23, a twenty-fourth point P24, a twenty-fifth point P25, a twenty-sixth point P26, a twenty-seventh point P27, and a twenty-eighth point P28 corresponding to positions in the second direction D2 illustrated in FIGS. 8 and 9 correspond to the negative and positive ends of first overlap portions 241a and second overlap portions 241b illustrated in FIG. 8 in the second direction D2.

When the liquid crystal element 1b refracts the emission light L, the first potential E1 is applied to the first electrodes 242 and the second potential E2 is applied to the second electrodes 243 by the control circuit.

Accordingly, the potential of the electric resistance film 241 changes in a zigzag pattern between the first potential E1 and the second potential E2 in the second direction D2. Specifically, in the electric resistance film 241, the potential of the first overlap portions 241a (for example, portion between the twenty-first point P21 and the twenty-second point P22) contacting the first electrodes 242 is equal to the first potential E1. The potential of first middle portions 241cl (for example, portion between the twenty-second point P22 and the twenty-third point P23) in which the second overlap portions 241b are positioned on the positive side in the second direction D2, among middle portions 241c between the first electrodes 242 and the second electrodes 243 in the electric resistance film 241, linearly changes from the first potential E1 to the second potential E2, from the negative side toward the positive side in the second direction D2.

The potential of the second overlap portions 241b (for example, portion between the twenty-third point P23 and the twenty-fourth point P24) contacting the second electrodes 243 in the electric resistance film 241 is equal to the second potential E2. The potential of second middle portions 241c2 (for example, portion between the twenty-fourth point P24 and the twenty-fifth point P25) in which the first overlap portions 241a are positioned on the positive side in the second direction D2, among the middle portions 241c between the first electrodes 242 and the second electrodes 243 in the electric resistance film 241, linearly changes from the second potential E2 to the first potential E1, from the negative side toward the positive side in the second direction D2.

The same first potential E1 as that to the first electrodes 242 is applied to the third electrode 50 by the control circuit. The potential difference between the first potential E1 and the second potential E2 is determined based on the angle between the fourth direction D4 and the third direction D3 and the angle between the fifth direction D5 and the third direction D3.

Through potential application to the first electrodes 242, the second electrodes 243, and the third electrode 50, the refractive index of the emission light L in the liquid crystal layer 30 changes in the second direction D2, and a phase difference occurs to the emission light L passing through the liquid crystal layer 30.

As for the phase of the emission light L passing through the liquid crystal layer 30 illustrated in FIG. 9, the phase at a position corresponding to the negative end of the second overlap portions 241b in the second direction D2 (for example, the twenty-third point P23) is taken as a reference (where the phase difference is 0 (zero)), and the maximum value of a phase difference caused by potentials applied to the first electrodes 242 and the second electrodes 243 in the second embodiment is referred to as the first phase difference R1.

The phase difference of the emission light L passing through the liquid crystal layer 30 changes in a zigzag pattern between 0 (zero) and the first phase difference R1 in the second direction D2. Specifically, the phase difference at portions of the liquid crystal layer 30 corresponding to the first overlap portions 241a is the first phase difference R1. The phase difference at the first middle portions 241cl linearly changes from the first phase difference R1 to 0 (zero), from the negative side toward the positive side in the second direction D2.

The phase difference at portions of the liquid crystal layer 30 corresponding to the second overlap portions 241b is 0 (zero). The phase difference at portions of the liquid crystal layer 30 corresponding to the second middle portions 241c2 of the electric resistance film 241 linearly changes from 0 (zero) to the first phase difference R1, from the negative side toward the positive side in the second direction D2.

As the phase difference of the emission light L passing through the liquid crystal layer 30 changes as illustrated in FIG. 9, the emission light L is refracted in the liquid crystal layer 30 and exits simultaneously in both the fourth direction D4 and the fifth direction D5 from the liquid crystal element 1b. The second potential E2 may be applied to the first electrodes 242 and the first potential E1 may be applied to the second electrodes 243 by the control circuit.

### Third Embodiment

The following describes a liquid crystal element 1c according to a third embodiment with focus on difference from the liquid crystal element 1 of the above-described first embodiment.

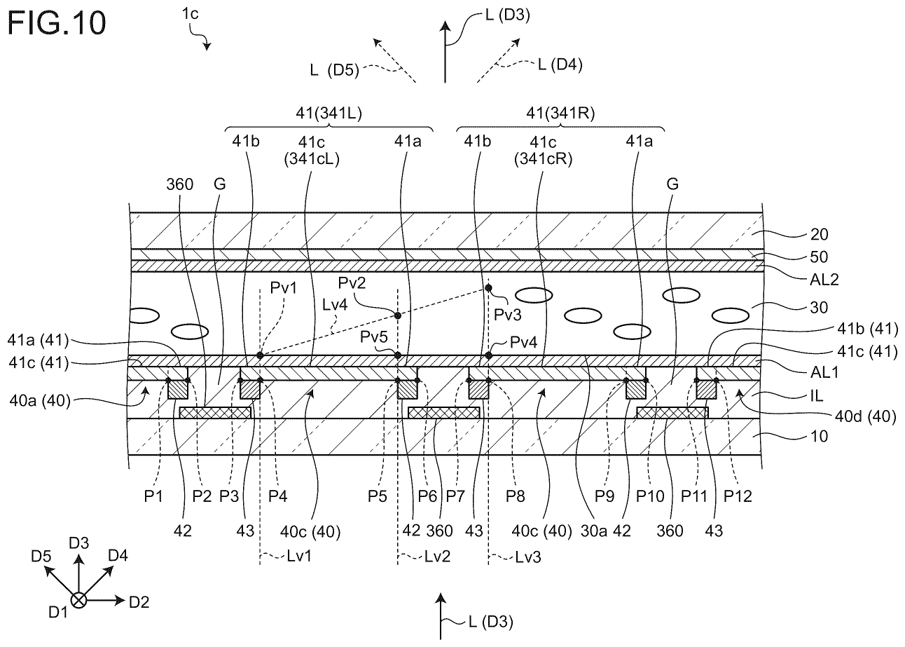

FIG. 10 is a sectional view of the liquid crystal element 1c according to a modification of the third embodiment of the present disclosure. The liquid crystal element 1c of the third embodiment includes a plurality of light-shielding layers 360 in addition to the configuration of the liquid crystal element 1 of the above-described first embodiment.

The light-shielding layers 360 are disposed on the first substrate 10. The light-shielding layers 360 each have a strip shape extending in the first direction D1 in a plan view. In a plan view, the light-shielding layers 360 each overlap a gap G between two element sets 40 adjacent to each other in the second direction D2. The light-shielding layers 360 prevent the emission light L from passing through the gaps G.

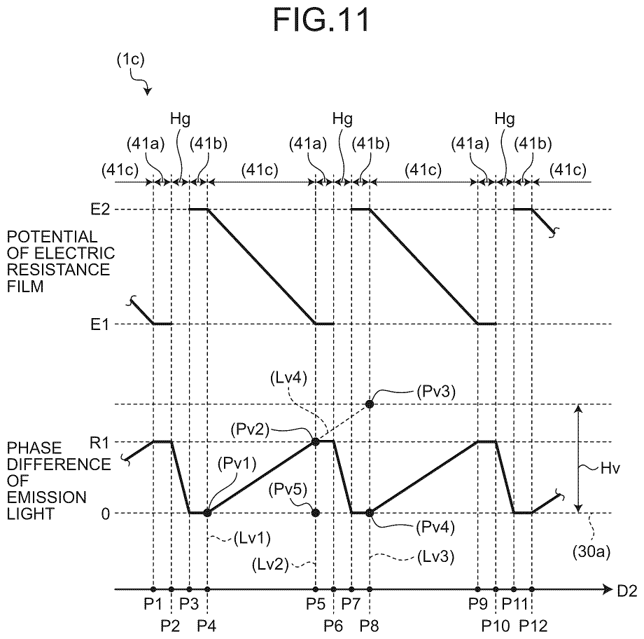

FIG. 11 is a diagram illustrating the potential of each electric resistance film 41 and the phase difference of the emission light L passing through the liquid crystal layer 30 when the liquid crystal element 1c according to the third embodiment refracts the emission light L in the fourth direction D4.

In the liquid crystal element 1c of the third embodiment, each gap G between two element sets 40 adjacent to each other in the second direction D2 is larger than in the liquid crystal element 1 of the above-described first embodiment. Accordingly, in FIGS. 10 and 11, a length Hg of each gap G in the second direction D2 (in FIG. 11, for example, length between the second point P2 and the third point P3) is longer than in FIGS. 4 and 5.

When the liquid crystal element 1c refracts the emission light L in the fourth direction D4, the first potential E1 is applied to the first electrodes 42 and the second potential E2 is applied to the second electrodes 43 by the control circuit as in the above-described first embodiment.

In this case, the potential of one electric resistance film 41 illustrated in FIG. 11 is the same as the potential of one electric resistance film 41 illustrated in FIG. 4. Through potential application to the first electrodes 42, the second electrodes 43, and the third electrode 50, the refractive index of the emission light L in the liquid crystal layer 30 changes in the second direction D2, and a phase difference occurs to the emission light L passing through the liquid crystal layer 30.

Similarly to the phase difference illustrated in FIG. 4, the phase difference of the emission light L passing through the liquid crystal layer 30 illustrated in FIG. 11 changes in a zigzag pattern between 0 (zero) and the first phase difference R1 in the second direction D2.

In the third embodiment, the length Hg of each gap G in the second direction D2 is determined as follows. First, a first virtual line Lv1, a second virtual line Lv2, a third virtual line Lv3, and a fourth virtual line Lv4 illustrated in FIGS. 10 and 11 will be described. Among two electric resistance films 41 adjacent to each other in the second direction D2 illustrated in FIG. 10, the electric resistance film 41 on the negative side in the second direction D2 is referred to as a first electric resistance film 341L, and the electric resistance film 41 on the positive side in the second direction D2 is referred to as a second electric resistance film 341R. The second electric resistance film 341R is an electric resistance film 41 adjacent to the first electric resistance film 341L on the first electrode 42 side of the first electric resistance film 341L in the second direction D2 among the electric resistance films 41.

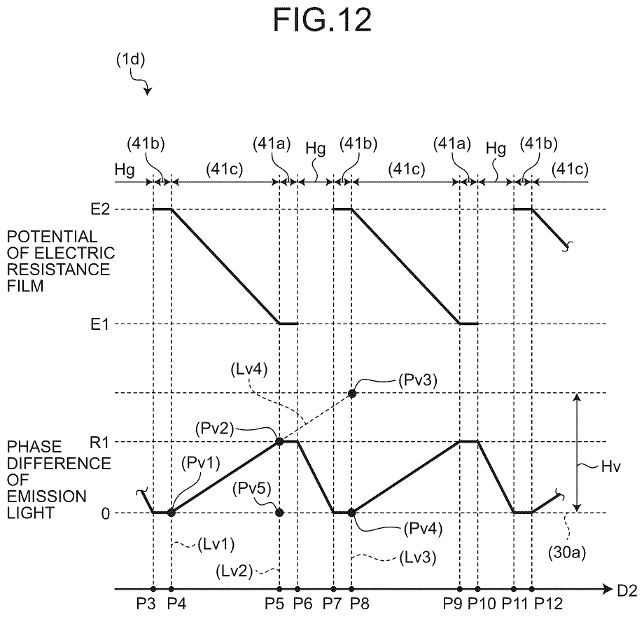

The surface of the liquid crystal layer 30 on the negative side in the third direction D3 is referred to as an entrance surface 30a. The emission light L is incident on the liquid crystal layer 30 from the entrance surface 30a. The entrance surface 30a corresponds to a dashed line representing the phase difference reference (0 (zero)) in FIGS. 11 and 12.

The first virtual line Lv1 is a virtual line that is parallel to the third direction D3 and passes through an end point (fourth point P4) of a middle portion 341cL (corresponding to “first portion”) on the second electrode 43 side in the first electric resistance film 341L.

The second virtual line Lv2 is a virtual line that is parallel to the third direction D3 and passes through an end point (fifth point P5) of the middle portion 341cL on the first electrode 42 side.

The third virtual line Lv3 is a virtual line that is parallel to the third direction D3 and passes through an end point (eighth point P8) of a middle portion 341cR (corresponding to “second portion”) on the second electrode 43 side in the second electric resistance film 341R.

The fourth virtual line Lv4 is a virtual line connecting a first virtual point Pv1 to a second virtual point Pv2, the first virtual point Pv1 is the intersection point of the first virtual line Lv1 and the entrance surface 30a, and the second virtual point Pv2 is a point on the second virtual line Lv2 at which the phase of the emission light L is the same as the phase of the emission light L at the first virtual point Pv1.

As illustrated in FIG. 11, the length between a third virtual point Pv3 and a fourth virtual point Pv4 is referred to as a virtual length Hv, the third virtual point Pv3 is the intersection point of the third virtual line Lv3 and the fourth virtual line Lv4, and the fourth virtual point Pv4 is the intersection point of the third virtual line Lv3 and the entrance surface 30a.

The above-described length Hg of each gap G is determined such that the virtual length Hv is equal to an odd multiple of the wavelength of the emission light L. When the length Hg of the gap G is determined in this manner, the liquid crystal element 1c refracts the emission light L further in the fourth direction D4 as compared to a case where the length Hg of the gap G is determined such that the virtual length Hv is not an odd multiple of the wavelength of the emission light L. In other words, in a case where the length Hg of the gap G is determined such that the virtual length Hv is an odd multiple of the wavelength of the emission light L, the emission light L refracted in the liquid crystal layer 30 is collected further in the fourth direction D4.

FIG. 12 is a diagram illustrating the potential of each electric resistance film 41 and the phase difference of the emission light L passing through the liquid crystal layer 30 when a liquid crystal element 1d according to a comparative example refracts the emission light L in the fourth direction D4.

The liquid crystal element 1d of the comparative example has the same configuration as that of the liquid crystal element 1c of the third embodiment except for the length Hg of each gap G. The length Hg of each gap G illustrated in FIG. 12 is longer than the length Hg of each gap G in the liquid crystal element 1c illustrated in FIG. 11. In the liquid crystal element 1d of the comparative example, the length Hg of each gap G illustrated in FIG. 12 is determined such that the virtual length Hv is an even multiple of the wavelength of the emission light L.

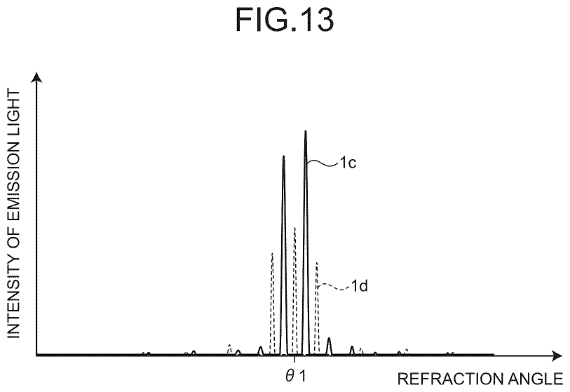

FIG. 13 is a graph illustrating an example of the relation between the refraction angle and the intensity of both the emission light L emitted from the liquid crystal element 1c of the third embodiment and the emission light L emitted from the liquid crystal element 1d of the comparative example.

In FIG. 13, the horizontal axis represents the refraction angle of the emission light L, and the vertical axis represents the intensity of the emission light L. In the example illustrated in FIG. 13, the liquid crystal element 1c of the third embodiment and the liquid crystal element 1d of the comparative example refract the emission light L in the fourth direction D4. The refraction angle corresponding to the fourth direction D4 is referred to as a first refraction angle θ1.

In the example illustrated in FIG. 13, the virtual length Hv in the liquid crystal element 1c of the third embodiment is 23 times the wavelength, and the virtual length Hv in the liquid crystal element 1d of the comparative example is 24 times the wavelength. In the phase difference of the emission light L illustrated in FIG. 11 and the phase difference of the emission light L illustrated in FIG. 13, the length between the second virtual point Pv2 and a fifth virtual point Pv5 that is the intersection point of the second virtual line Lv2 and the entrance surface 30a is 12 times the wavelength and equal between the phase differences.

The degree of the gradient of the phase difference at portions of the liquid crystal layer 30 corresponding to the middle portions 41c is equal between the liquid crystal element 1c of the third embodiment and the liquid crystal element 1d of the comparative example. Specifically, the degree of the gradient between the fourth point P4 and the fifth point P5 (and the degree of the gradient between the eighth point P8 and the ninth point P9) is equal between the phase difference of the emission light L illustrated in FIG. 11 and the phase difference of the emission light L illustrated in FIG. 13.

As illustrated in FIG. 13, the intensity of the emission light L is scattered around the first refraction angle θ1. The degree of the scattering of the liquid crystal element 1c of the third embodiment is smaller than the degree of the scattering of the liquid crystal element 1d of the comparative example. Moreover, the maximum value of the intensity of the emission light L from the liquid crystal element 1c of the third embodiment is larger than the maximum value of the intensity of the emission light L from the liquid crystal element 1d of the comparative example. Accordingly, the liquid crystal element 1c of the third embodiment refracts the emission light L further in the fourth direction D4 as compared to the liquid crystal element 1d of the comparative example.

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

It should be understood that the present disclosure provides any other effects achieved by aspects described above in the above-described embodiments, such as effects that are clear from the description of the present specification or effects that could be thought of by the skilled person in the art as appropriate.

What is claimed is:

1. A liquid crystal element comprising:
a first substrate on which a plurality of element sets are disposed, each element set including an electric resistance film, a first electrode, and a second electrode, the first electrode and the second electrode being electrically coupled to the electric resistance film;
a second substrate on which a third electrode is disposed; and
a liquid crystal layer positioned between the first and second substrates, wherein
each of the electric resistance films has a strip shape extending in a first direction in a plan view,
in a plan view, the first electrode and the second electrode extend in the first direction and overlap the electric resistance film in a state in which the first electrode and the second electrode face each other in a second direction orthogonal to the first direction,
the element sets are arranged in the second direction in a plan view, and
the third electrode overlaps the electric resistance films in a plan view.

2. The liquid crystal element according to claim 1, wherein the first electrode and the second electrode contact the electric resistance film.

3. The liquid crystal element according to claim 1, wherein a first potential is applied to the first electrode, and a second potential higher than the first potential is applied to the second electrode.

4. A liquid crystal element comprising:
a first substrate on which an electric resistance film, a plurality of first electrodes, and a plurality of second electrodes are disposed, the first and second electrodes being electrically coupled to the electric resistance film;
a second substrate on which a third electrode is disposed; and
a liquid crystal layer positioned between the first and second substrates, wherein
in a plan view, the first and second electrodes extend in a first direction and overlap the electric resistance film in a state in which the first electrode and the second electrode are alternately arranged in a second direction orthogonal to the first direction, and
the third electrode overlaps the electric resistance film in a plan view.

5. A liquid crystal element comprising:
a first substrate on which a plurality of element sets and a plurality of light-shielding layers are disposed, each element set including an electric resistance film, a first electrode, and a second electrode, the first electrode and the second electrode being electrically coupled to the electric resistance film;
a second substrate on which a third electrode is disposed; and
a liquid crystal layer positioned between the first and second substrates, wherein
the electric resistance films each have a strip shape extending in a first direction in a plan view,
in a plan view, the first electrode and the second electrode extend in the first direction and overlap the electric resistance film in a state in which the first electrode and the second electrode face each other in a second direction orthogonal to the first direction,
the element sets are arranged in the second direction in a plan view, and
in a plan view, each of the light-shielding layers has a strip shape extending in the first direction and overlaps a gap between two of the element sets adjacent to each other in the second direction, and
the third electrode overlaps the electric resistance films in a plan view.

6. The liquid crystal element according to claim 5, wherein
light is incident on the liquid crystal layer from an entrance surface on the first substrate side in a third direction orthogonal to the first and second directions,
the first electrode and the second electrode contact the electric resistance film,
in a sectional shape along a plane orthogonal to the first direction when a first potential is applied to the first electrode and a second potential higher than the first potential is applied to the second electrode,
a first virtual line is a virtual line that is parallel to the third direction and passes through an end point of a first portion on the second electrode side in a first electric resistance film among the electric resistance films, the first portion being positioned between the first electrode and the second electrode in the second direction,
a second virtual line is a virtual line that is parallel to the third direction and passes through an end point of the first portion on the first electrode side,
a third virtual line is a virtual line that is parallel to the third direction and passes through an end point of a second portion on the second electrode side in a second electric resistance film adjacent to the first electric resistance film on the first electrode side of the first electric resistance film in the second direction among the electric resistance films, the second portion being positioned between the first electrode and the second electrode in the second direction,
a fourth virtual line is a virtual line connecting a first virtual point to a second virtual point, the first virtual point being an intersection point of the first virtual line and the entrance surface, the second virtual point is a point on the second virtual line at which the phase of the light is the same as the phase of the light at the first virtual point, and
the length between a third virtual point and a fourth virtual point is an odd multiple of the wavelength of the light, the third virtual point being the intersection point of the third and fourth virtual lines, the fourth virtual point being the intersection point of the third virtual line and the entrance surface.
